(19) United States
(12) Patent Application Publication
(10) Pub. No.: US 2002/0083432 A1
(43) Pub. Date: Jun. 27, 2002

(54) Over the air RF wireless data modem programming

(76) Inventors: Slim Salah Souissi, San Diego, CA (US); Michael Scott Andrews, Escondido, CA (US); Ambrose W. C. Tam, Calgary (CA); John Andrew Adams, Escondido, CA (US)

Correspondence Address: COUDERT BROTHERS, 3rd Floor, 600 Beach Street, San Francisco, CA, 94109, US

(21) Appl. No.: 09/935,376

(22) Filed: Aug. 22, 2001

Related U.S. Application Data
(60) Provisional application No. 60/227,147, filed on Aug. 22, 2000.

(51) Int. Cl. G06F 9/445

(52) U.S. Cl. 717/178

(57) ABSTRACT

The present invention is directed at a method and apparatus for updating a detachable software configurable wireless radio frequency modem that uses operating software. The RF modem uses an attached host computing device to download an operating software update to the RF modem's memory to reconfigure the RF modem. There is also a recovery feature that allows the original version of the RF modem's operating software to be saved and recovered if an attempt to update the RF modem's operating software is unsuccessful.

This application claims the benefit of U.S. Provisional Application No. 60/227,147 filed Aug. 22, 2000.

### FIELD OF INVENTION

The present invention is directed to wireless radio frequency modems and, more specifically, to wireless radio frequency modems that can be reconfigured using software downloaded over-the-air by an attached host computing device.

### BACKGROUND OF THE INVENTION

Current wireless radio frequency (“RF”) modems that cooperatively operate with a host computing device (“host computer”) typically include: (1) a radio portion, also called an RF front end or an RF head; (2) a modulator/demodulator portion, also called a baseband processing unit or baseband chip; (3) a central processing unit (“CPU”) or processor; (4) memory; and (5) an interface. These modems typically operate using software code to communicate between a user and a base station. The above modem components collectively operate during a wireless communications process to receive an electromagnetic RF signal in a receive mode, wherein the RF signal contains information to be extracted from the received RF signal, and in a transmit mode, wherein the components work collectively to transmit an electromagnetic RF signal and the RF signal contains the information to be transmitted. Moreover, during the receive and transmit modes, the modem components collectively operate to perform three principal modem functions: RF conversion, baseband processing and protocol stack control.

Typically during RF conversion, the RF head receives the RF signal during the receive mode and converts that RF signal into a modulated baseband analog signal and, during the transmit mode, the RF head converts a modulated baseband analog signal into an RF signal for transmission. During baseband processing, the baseband processing unit in the receive mode demodulates the modulated baseband analog signal by extracting a plurality of data bits that correspond to the information being received. In the transmit mode, the baseband processing unit generates the modulated baseband analog signal for processing by the RF head.

As part of the above wireless communications process, data bits being transmitted are wrapped with protocol bits of data to facilitate transmission, routing, and receiving of the data bits. Likewise, this protocol data must be removed to accurately reproduce, in the receiving RF modem, the data that was sent. The adding or stripping of the protocol bits, also called protocol stack control, is generally performed by the processor in the RF modem under the control of a protocol stack software program stored in the RF modem's memory. Finally, the interface feeds the data bits from the host computer to the RF modem for processing and transmission, and feeds to the host computer the reproduced data bits that were extracted from the received RF signal.

The host computer may typically be a laptop or palmtop computer, or a Personnel Digital Assistant (PDA), such as a Jornada 545 from Hewlett Packard Co., an IPAQ computer from Compaq Corporation, a Palm III or Palm V from Palm Corp. or a Visor from Handspring Corp. The host computer may also be a point of sale terminal, or some other computing system. Typical interfaces between the wireless RF modem and the host computer are RS-232, USB, Parallel Port, IrDa, PCMCIA, Flash, Compact Flash, or a low voltage serial interface. However, other interfaces are also used, including a variety of other standard or proprietary interfaces. Moreover, there are many wireless RF standards that must be considered in the design of any wireless RF modem. Some examples include: circuit switched commercial telecommunications standards including AMPS, CDMA (IS95A & B), and GSM; packet switched standards including CDPD, 1XRTT, GPRS, EDGE, and W-CDMA; and proprietary wide area wireless networks such as Metricom, Re-Flex, FLEX, Mobitex, and ARDIS.

Wireless RF modem use has grown very rapidly during recent years and is projected to continue to grow. Whereas, only a few kinds of host computers were equipped in the past with wireless RF modems, the trend of incorporating such modems is growing, especially with respect to wireless RF modems that plug into laptops and PDAs. Competitive pressures cause manufacturers to look for ways to reduce costs of wireless RF modems. Typically, the detachable wireless RF modems that work cooperatively with host computers perform all of their functions with internal software and hardware. They rely on the host computers only to provide data to be transmitted and a receptacle for data received by the modem from the received RF signal.

Accordingly, when software changes need to be made to the RF wireless modems, the modems typically either need to be returned to the factory for reprogramming or the user has to go through a very complicated procedure of copying files and running a program on a personal computer (“PC”) to update the modem (if installed in the PC) or run a PC to update a PDA and then run a program on the PDA to update the modem. For instance, updates may require the docking of the PDA into a docking station connected to a PC. The new modem software is then loaded by the PC to the PDA. The PDA then runs a loader program that programs the modem. For laptops utilizing a PCMCIA card modem, the software is first installed onto the laptop and then the modem is programmed through the PCMCIA interface. As can be seen, a lot of manual steps are required using the current methodologies. These steps are difficult, not user friendly, and prone to errors.

Additionally, if the new software does not work properly, it may be difficult if not impossible to go back to the previous version. The Software Defined Radio (SDR) forum is planning to establish a standard for software downloads over the air. However the SDR forum approach and that of other standards groups is too complicated for use by, for example, an equipment manufacturer wanting to update the software in a wireless RF modem.

What is needed is a more efficient and reliable way to update the software code in wireless RF modems.

### SUMMARY OF THE INVENTION

The present invention is directed at addressing the above-mentioned shortcomings, disadvantages, and problems of the prior art. The present invention provides for a method and apparatus for updating a detachable software configurable wireless radio frequency (“RF”) modem that operates using operating software and is connected to a host computing device, said RF modem comprising an antenna, an RF head, a baseband processing unit, a modem central processing unit (“CPU”), a modem memory that includes a loader program to enable the modem CPU to download an operating software update, and an interface for connecting said RF modem to said host computing device, said host computing device comprising a host CPU and a host memory, said RF modem constructed to cooperatively operate with said host computing device to enable said RF modem to be reconfigured according to said operating software update.

The preferred method according to the present invention comprises the steps of: (a) notifying a user of said host computing device and said RF modem that an operating software update is available to reconfigure said RF modem; (b) determining whether said user authorizes reconfiguration of said RF modem using said reprogramming software, and if yes, proceeding to step (c); (c) downloading said operating software update to said host computing device via said RF modem; (d) causing said host computing device to download said operating software update to said modem memory under the control of said loader program; and (e) reconfiguring said RF modem to operate according to said operating software update. The method may also include the step of saving a copy of said RF modem's original operating software.

A preferred modem according to the present invention comprises configuring the RF modem to enable, upon authorization of a user of said host computing device and said RF modem, the download of an RF modem operating software update to said host computing device via said RF modem, and a loader program stored in said modem memory to cause said modem CPU to download said operating software update from said host computing device to said RF modem and to reconfigure said RF modem so as to cause said modem to operate according to said operating software update.

An object of the present invention is to provide a unique architecture for a wireless RF modem that is intended to provide an efficient, timely, and low cost over the air upgrade of the RF modem's operating software. A key advantage of one embodiment of the present invention is a recovery feature that allows the original version of the modem's operating software to be saved and recovered. Recovery of the original operating software is advantageous if the updated operating software subsequently is no longer desired by the user or if the attempt to update the RF modem's operating software was unsuccessful.

Another advantage of the present invention is that RF modems that are already in the field can receive operating software updates without the units having to be returned to a factory, dealer or service center for reprogramming. Moreover, a service provider to a plurality of users of RF modems can more efficiently download new and enhanced value-added RF modem features to update all user wireless RF modems to improve their functionality.

### BRIEF DESCRIPTION OF THE DRAWINGS

The forgoing aspects and many of the attendant advantages of the present invention will become more readily appreciated by reference to the following detailed description, when taken in conjunction with the accompanying drawings, wherein:

FIG. 1 is a block diagram of a prior art wireless RF modem that is designed to be plugged into a PCMCIA slot connector within a host computer;

FIG. 2 is a block diagram of prior art combination of the wireless RF modem of FIG. 1 and a host computer with a PCMCIA slot connector;

FIG. 3 is a block diagram of a wireless RF modem according to a preferred embodiment of the present invention; and

FIG. 4 is a flow chart illustrating a method for updating RF modem 300 according to a preferred embodiment of the present invention.

### DETAILED DESCRIPTION OF THE INVENTION

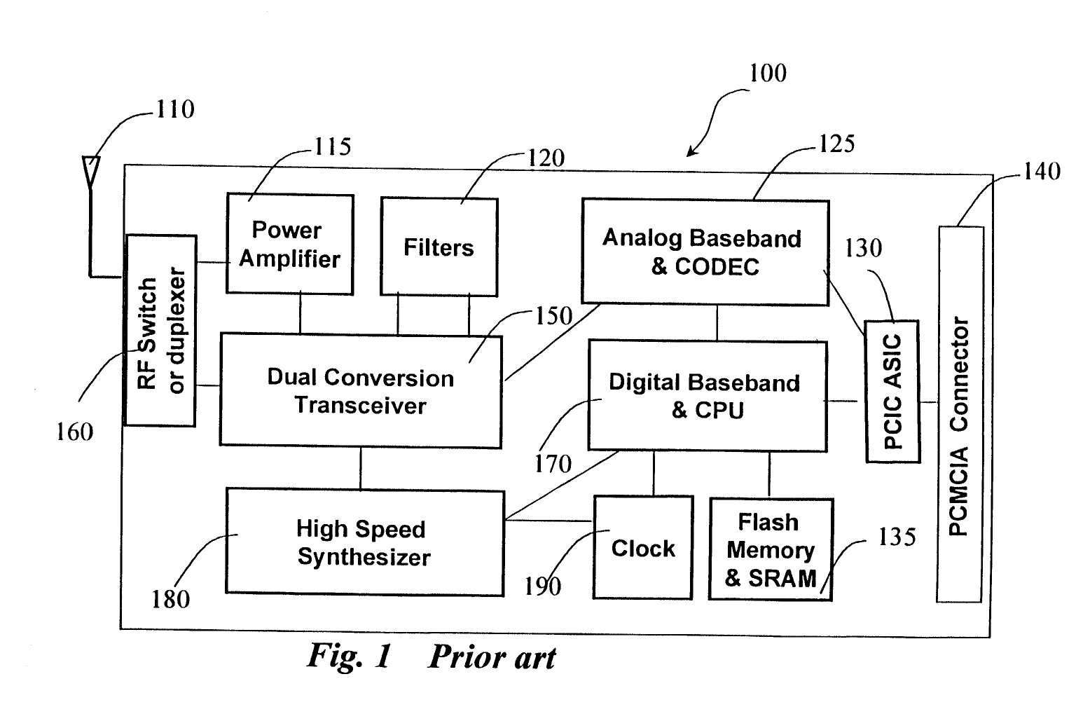

FIG. 1 is a block diagram that illustrates a prior art wireless RF modem 100 that is designed to be plugged into a PCMCIA slot connector within a host computer. In this representation of prior art RF modem 100, Dual Conversion Transceiver 150, High Speed Synthesizer 180, Power Amplifier 115, Filters 120, and RF Switch 160 comprise an RF head, which performs RF conversion. Conventional versions of Dual Conversion Transceiver 150 and High Speed Synthesizer 180 are available from Texas Instruments of Dallas, Tex. RF switch 160 may be a transmit/receive switch or a duplexer, as required by a given air standard.

Analog Baseband and Codec 125 and Digital Baseband and CPU 170 work in conjunction with Flash Memory and SRAM 135 and comprise the baseband processing unit and the CPU, which performs baseband processing and protocol stack control. Analog Baseband and Codec 125 and Digital Baseband and CPU 170 are available from Analog Devices of Norwood, Md. RF modem 100 also includes an Antenna 110, a Clock 190, a PCIC ASIC 130, and a PCMCIA connector 140. The above components of RF modem 100 are electrically connected as illustrated by the solid lines in FIG. 1 between those components.

RF modem 100 operates as follows. In the receive mode, an electromagnetic RF signal is received at Antenna 110 which is connected to RF switch 160. The received RF signal is routed through RF switch 160 to Dual Conversion Transceiver 150, which converts the RF signal into a modulated baseband analog signal for baseband processing. Dual Conversion Transceiver 150 operates using various receive and transmit variable frequency oscillator signals that are provided by High Speed Synthesizer 180. The modulated RF signal from Dual Conversion Transceiver 150 is fed to Power Amplifier 115 which also is fed a signal that controls the power output so that Power Amplifier 115 can deliver requested power to RF Switch 160. Various filters as required for Dual Conversion Transceiver 150 are shown as Filters 120. The modulated baseband analog signal from Dual Conversion Transceiver 150 is fed into Analog Baseband and Codec 125 for proper demodulation to extract data bits comprising true data, which is representative of the information being received, protocol bits of data, and any security coding. Digital Baseband and CPU 170 further processes the received signal by executing a protocol stack software program, to separate the true data from the protocol data and to remove any security coding. Digital Baseband and CPU 170 then sends the true data through a timing and interface PCIC ASIC device 130 to PCMCIA connector 140 to be fed to a host computer. Clock 190 provides a system clock to Digital Baseband and CPU 170 and High Speed Synthesizer 180. Flash Memory and SRAM 135 provide for program storage and variable storage for Digital Baseband and CPU 170, e.g. storing the protocol stack software program.

In the transmit mode, true data to be transmitted is fed through PCMCIA Connector 140, through PCIC ASIC 130, to Digital Baseband and CPU 170, wherein the true data is wrapped with protocol data and any necessary security data and sent to Analog Baseband and Codec 125. Analog Baseband and Codec 125 generates the modulated baseband analog signal and sends it to Dual Conversion Transceiver 150 to generate the electromagnetic RF signal. The RF signal to be transmitted is then amplified by Power Amplifier 115 and sent through RF switch 160 to Antenna 110 for transmission. As illustrated in FIG. 1, prior art RF modem 100 has its own CPU and its own memory, and all modem functions are performed and controlled by components housed within RF modem 100.

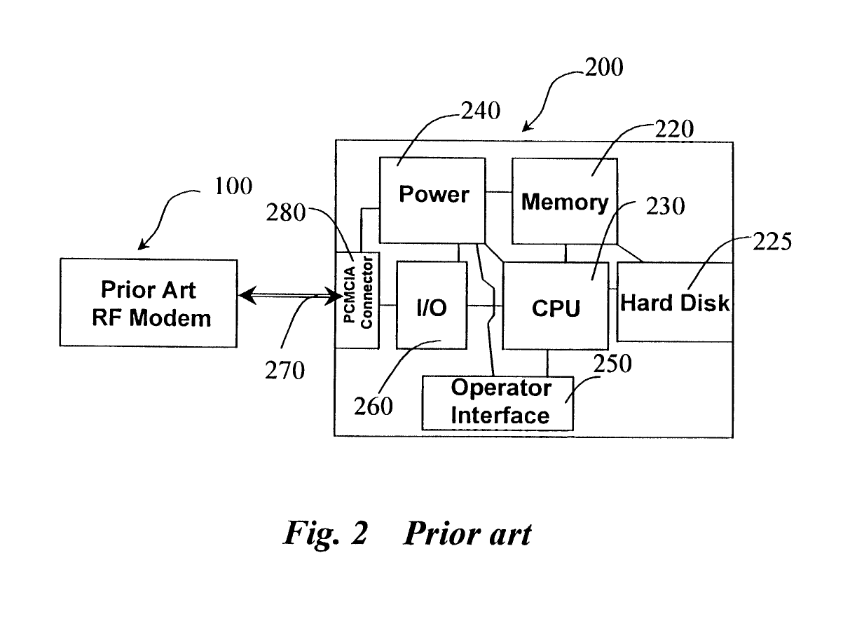

FIG. 2 is a block diagram illustrating a prior art combination of wireless RF modem 100 of FIG. 1 and a host computer 200 with a PCMCIA slot connector 280. Double arrow 270 indicates an action of inserting and connecting wireless RF modem 100 to host computer 200, such that PCMCIA slot connector 280 is connected to PCMCIA Connector 140 in RF modem 100.

Host computer 200 contains a power source 240, a memory 220 that typically comprises a ROM, RAM, SRAM, Flash, or other combination of memory accessible by a CPU 230. Computer system Input/Output (I/O) circuitry is shown connecting CPU 230 to PCMCIA connector 280. Data to be sent or received by CPU 230 is communicated to PCMCIA connector 280 using standard software drivers for the connection and standard AT Modem commands. Operator interface 250 can be programmed to display information concerning the operation of the RF modem 100.

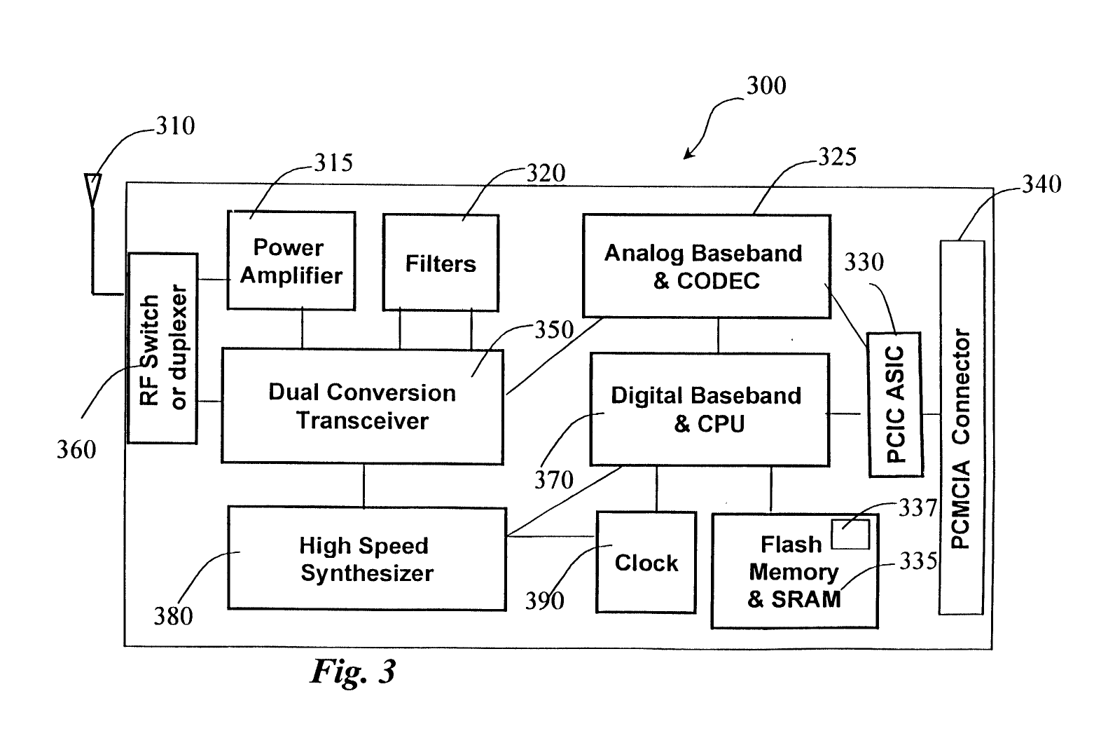

FIG. 3 is a block diagram illustrating a wireless RF modem 300 according to the preferred embodiment of the present invention. RF modem 300 is preferably a detachable software configurable wireless RF modem that operates using operating software and can be connected to a host computer (not illustrated), wherein RF modem 300 uses the host computer to download an available operating software update to reconfigure RF modem 300. The operating software update can include a variety of improvements to RF modem 300 as understood by those skilled in the art. Moreover, RF modem 300 may be designed to enable data to be transferred to and from the host computer via a cellular carrier to reach an address on the Internet. In packet-switched networks, such as CDPD, the data goes from the cellular site to the Internet. Whereas with circuit switched networks, the data is connected with an Internet service provider (“ISP”) modem.

In this representation of RF modem 300, Dual Conversion Transceiver 350, High Speed Synthesizer 380, Power Amplifier 315, Filters 320, and RF Switch 360 comprise an RF head, which performs RF conversion. Dual Conversion Transceiver 350 and High Speed Synthesizer 380 are available from Texas Instruments of Dallas, Tex. RF switch 360 may be a transmit/receive switch or a duplexer, as required by a given air standard.

Analog Baseband and Codec 325 and Digital Baseband and CPU 370 work in conjunction with Flash Memory and SRAM 335 and comprise the baseband processing unit and the CPU, which performs baseband processing and protocol stack control. It is within the Flash Memory and SDRAM 335 that the modem operating software program resides. Analog Baseband and Codec 325 and Digital Baseband and CPU 370 are available from Analog Devices of Norwood, Md. RF modem 300 also includes an Antenna 310, a Clock 390, a PCIC ASIC 330, and a PCMCIA connector 340. The above components of RF modem 300 are electrically connected as illustrated by the solid lines in FIG. 3 between those components.

In addition, FIG. 3 illustrates a small reserved section of Flash Memory and SRAM 335 (a “loading kernel”), shown as 337, which is encoded with program loader software for CPU 370. The loader program enables an operating software update to be downloaded to Flash Memory and SRAM 335 to reconfigure RF modem 300 according to the operating software update. Moreover loading kernel 337 remains unchanged when RF modem 300 is reconfigured and reset.

RF modem 300 operates as follows. In the receive mode, an electromagnetic RF signal is received at Antenna 310 which is connected to RF switch 360. The received RF signal is routed through RF switch 360 to Dual Conversion Transceiver 350, which converts the RF signal into a modulated baseband analog signal for baseband processing. Dual Conversion Transceiver 350 operates using various receive and transmit variable frequency oscillator signals that are provided by High Speed Synthesizer 380. The modulated RF signal from Dual Conversion Transceiver 350 is fed to Power Amplifier 115 which also is fed a signal that controls the power output so that Power Amplifier 315 can deliver requested power to RF Switch 360. Various filters as required for Dual Conversion Transceiver 350 are shown as Filters 320. The modulated baseband analog signal from Dual Conversion Transceiver 350 is fed into Analog Baseband and Codec 325 for proper demodulation to extract data bits comprising true data, which is representative of the information being received, protocol bits of data, and any security coding. Digital Baseband and CPU 370 further processes the received signal by executing a protocol stack software program, to separate the true data from the protocol data and to remove any security coding. Digital Baseband and CPU 370 then sends the true data through a timing and interface PCIC ASIC device 330 to PCMCIA connector 340 to be fed to a host computer. Clock 390 provides a system clock to Digital Baseband and CPU 370 and High Speed Synthesizer 380. Flash Memory and SRAM 335 provide for program storage and variable storage for Digital Baseband and CPU 370, e.g., storing the protocol stack software program.

In the transmit mode, true data to be transmitted is fed through PCMCIA Connector 340, through PCIC ASIC 330, to Digital Baseband and CPU 370, wherein the true data is wrapped with protocol data and any necessary security data and sent to Analog Baseband and Codec 325. Analog Baseband and Codec 325 generates the modulated baseband analog signal and sends it to Dual Conversion Transceiver 350 to generate the electromagnetic RF signal. The RF signal to be transmitted is then amplified by Power Amplifier 315 and sent through RF switch 360 to Antenna 310 for transmission. Finally, an update program included in the attached host computer (not illustrated) enables the host computer to download an operating software update to Flash Memory and SRAM 335 to reconfigure RF modem 300 according to the operating software update.

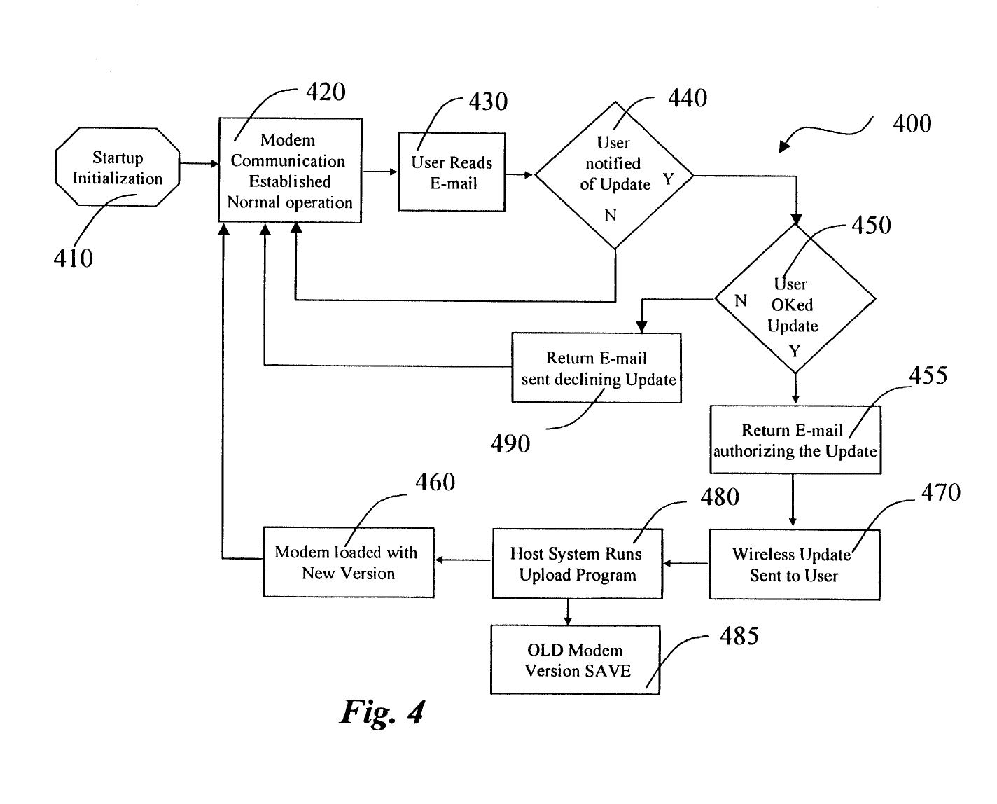

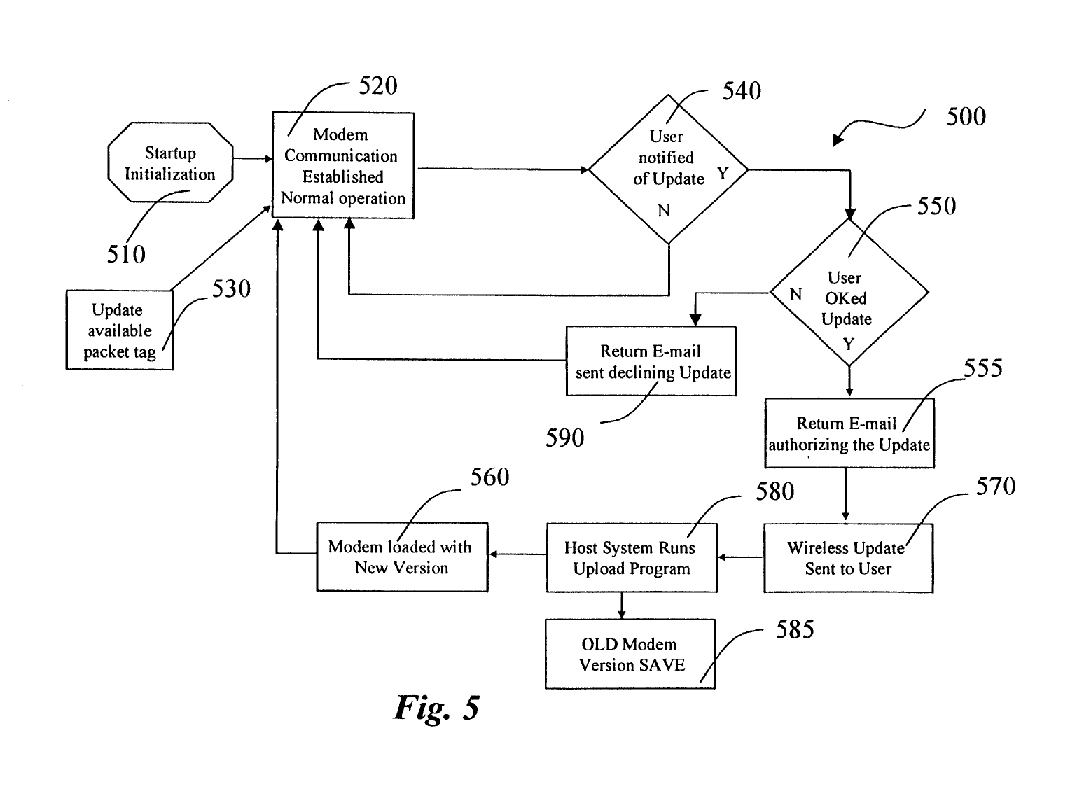

FIG. 4 is a flow chart illustrating a method 400 for updating RF modem 300 of FIG. 3 according to a preferred embodiment of the present invention. This method may be used with either fixed Internet Protocol (“P”) address or dynamic IP address RF wireless modems. After the host computer is turned on in Startup Initialization step 410, RF modem communication is established and normal operation of the host computer ensues at step 420, provided a user of the host computer and RF modem is in a proper service area. At step 440, the user is notified that an operating software update is available to reconfigure the RF modem. Preferably the notice is sent via a coded e-mail from a manufacturer or distributor of the RF modem directly to an IP address of the RF modem. For dynamically assigned IP addresses, the e-mail is sent over the Internet to the user's specified e-mail. For a fixed IP address such as CDPD, the IP address is assigned during activation and does not change. Also, for fixed IP address RF modems, the RF modem responds back to the sender that it has received the operating software update notice and has notified the user of the pending update.

The user must authorize the operating software update to cause the RF modem to be reconfigured. If the user declines the operating software update at step 450 the RF modem continues to operate using its original operating software. If the user authorizes the operating software update at step 450, the operating software update is automatically downloaded via the RF modem to the host computer at step 470. The operating software update may be sent to the host computer tagged with an RF modem equipment identification.

Preferably the user authorizes or declines the operating software update via a return e-mail to the manufacturer or distributor, at either step 490 or step 455. However, the user may authorize or decline the operating software update by other conventional methods known in the art. Moreover, when the user authorizes the operating software update, one way to accomplish the wireless download is to have the user request a file, containing the operating software update, using standard Internet file transfer protocol (ftp).

After receiving the operating software update, the host computer executes a host loading program and CPU 370 of FIG. 3 executes the RF modem loader program, at step 480. The host loading program communicates with the RF modem loader program and first saves a memory copy of the RF modem's current operating software at step 485, and then completes the upload of the new program into the RF modem memory at step 460. The RF modem is then reset so that the RF modem can establish normal operation at step 420 according to the operating software update. The host computer may notify the user when step 470 is complete, wherein the user selects a modem update function to cause the host computer to download a complete memory map of the RF modem to verify that it is correct before steps 480, 485, 460 and 420 are performed.

If the operating system in the host computer allows concurrent activities, other non-wireless activities may take place on the host computer during the RF modem update. If the user experiences any problems with the new modem software, the user may select to reload the version of RF modem operating software that was saved at step 485.

In a method for updating an RF modem according to another embodiment of the present invention, the user is notified of an available operating software update via a data packet that is tagged as an update notice. This method is only appropriate for reconfiguring fixed IP address RF modems. All other steps in the method according to this embodiment are identical to the steps in FIG. 4 as described above.

In a method for updating an RF modem according to another embodiment of the present invention, an inquiry by the user causes the user to be notified of an available operating software update to reconfigure the RF modem. All other steps in the method according to this embodiment are identical to the steps in FIG. 4 as described above.

The embodiments of the over the air wireless RF modem programming described above are illustrative of the principles of the present invention and are not intended to limit the invention to the particular embodiments described. Other embodiments of the present invention can be adapted for use in any RF wireless environment. Accordingly, while the preferred embodiment of the invention has been illustrated and described, it will be appreciated that various changes can be made therein without departing from the spirit and scope of the invention

What is claimed is:

1. A method for updating a detachable software configurable wireless radio frequency (“RF”) modem that operates using operating software and is connected to a host computing device, said RF modem comprising an antenna, an RF head, a baseband processing unit, a modem central processing unit (“CPU”), a modem memory that includes a loader program to enable the modem CPU to download an operating software update, and an interface for connecting said RF modem to said host computing device, said host computing device comprising a host CPU and a host memory, said RF modem constructed to cooperatively operate with said host computing device to enable said RF modem to be reconfigured according to said operating software update, said method comprising the steps of:
(a) notifying a user of said host computing device and said RF modem that an operating software update is available to reconfigure said RF modem;
(b) determining whether said user authorizes reconfiguration of said RF modem, and if yes, proceeding to step (c);
(c) downloading said operating software update to said host computing device via said RF modem;
(d) causing said host computing device to download said operating software update to said modem memory under the control of said loader program; and
(e) reconfiguring said RF modem to operate according to said operating software update.

2. The method of claim 1, further comprising the step of saving a copy of said RF modem's original operating software.

3. The method of claim 1, further comprising the step of notifying said user that the download of said operating software update to said host computing device is complete and ready for installation in said RF modem, before performing step (d).

4. The method of claim 1, wherein said user is notified via an e-mailed message.

5. The method of claim 1, wherein said user is notified via a direct data packet that is tagged as a notice sent to a fixed Internet Protocol address.

6. The method of claim 1, wherein an inquiry by said user causes the user to be notified of the availability of said operating software update.

7. The method of claim 1, wherein said operating software update is downloaded to said host computing device using a standard-Internet file transfer protocol.

8. A method for updating a detachable software configurable wireless radio frequency (“RF”) modem that operates using operating software and is connected to a host computing device, said RF modem comprising an antenna, an RF head, a baseband processing unit, a modem central processing unit (“CPU”), a modem memory that includes a loader program to enable the modem CPU to download an operating software update, and an interface for connecting said RF modem to said host computing device, said host computing device comprising a host CPU and a host memory, said RF modem constructed to cooperatively operate with said host computing device to enable said RF modem to be reconfigured according to said operating software update, said method comprising the steps of:
(a) notifying a user of said host computing device and said RF modem that an operating software update is available to reconfigure said RF modem;
(b) determining whether said user authorizes reconfiguration of said RF modem using said reprogramming software, and if yes, proceeding to step (c);
(c) downloading said operating software update to said host computing device via said RF modem;
(d) saving a copy of said RF modem's original operating software;
(e) causing said host computing device to download said operating software update to said modem memory under the control of said loader program; and
(f) reconfiguring said RF modem to operate according to said operating software update.

9. The method of claim 8, further comprising a step of determining whether said user wants to reinstall the original software saved at step (d) and, if so, causing said original software to be downloaded to said modem memory and reconfiguring said RF modem to operate according to said original operating software.

10. A detachable software configurable wireless radio frequency (“RF”) modem that operates using operating software and is connected to a host computing device, said RF modem having an antenna, an RF head, a baseband processing unit, a modem central processing unit (“CPU”), a modem memory and an interface for connecting said RF modem to said host computing device, said host computing device having a host CPU and a host memory, the improvement comprising:
said RF modem configured to enable, upon authorization of a user of said host computing device and said RF modem, the download of an RF modem operating software update to said host computing device via said RF modem; and
a loader program stored in said modem memory to cause said modem CPU to download said operating software update from said host computing device to said RF modem and to reconfigure said RF modem so as to cause said modem to operate according to said operating software update.

11. A system for providing wireless data communications comprising:
(a) detachable software configurable wireless radio frequency (“RF”) modem that operates using operating software, said RF modem comprising:
(1) an antenna;
(2) an RF head coupled to said antenna;
(3) a baseband processing unit coupled to said RF head;
(4) a modem central processing unit (“CPU”) coupled to said baseband processing unit and said RF head;
(5) a modem memory coupled to said baseband processing unit and said modem CPU, said modem memory including a loader program; and
(6) an interface coupled to said baseband processing unit and said modem CPU; and
(b) a host computing device physically coupled to said RF modem via said interface, said host computing device comprising a host CPU coupled to a host memory, wherein said RF modem is operative to enable, upon authorization of a user of said host computing device and said RF modem, the download of an RF modem operating software update to said host computing device via said RF modem, and said loader program stored in said modem memory is operative to cause said modem CPU to download said operating software update from said host computing device to said RF modem and to reconfigure said RF modem so as to cause said modem to operate according to said operating software update.

12. The system of claim 11, further comprising a backup memory for saving a copy of said RF modem's original operating software.

13. The system of claim 12, wherein said backup memory is included in said modem memory.
